(19) United States
(12) Patent Application Publication
(10) Pub. No.: US 2026/0242595 A1
(43) Pub. Date: Aug. 20, 2026

(54) RESIN COMPOSITION FOR FILM MOLDING, FILM, AND LAMINATE

(71) Applicant: KANEKA CORPORATION, Osaka (JP)

(72) Inventors: Naoya Kamikariya, Osaka (JP); Fuminobu Kitayama, Osaka (JP)

(73) Assignee: KANEKA CORPORATION, Osaka (JP)

(21) Appl. No.: 19/644,697

(22) Filed: Apr. 10, 2026

Related U.S. Application Data
(63) Continuation of application No. PCT/JP2024/035784, filed on Oct. 7, 2024.

(30) Foreign Application Priority Data
Oct. 12, 2023 (JP) 2023-176396

(51) Int. Cl. C08L 67/08; C08J 5/18; C08K 3/34; C08K 5/053; C08L 67/04

(52) U.S. Cl. CPC C08L 67/08; C08J 5/18; C08K 3/346; C08K 5/053; C08L 67/04; C08J 2367/04; C08J 2367/08; C08J 2467/04; C08J 2467/08; C08K 2201/019; C08L 2201/06; C08L 2203/162; C08L 2205/025; C08L 2205/03

(57) ABSTRACT

A resin composition for film molding contains a poly(3-hydroxyalkanoate) resin (A) and a polylactic acid resin (B). The poly(3-hydroxyalkanoate) resin (A) contains a poly(3-hydroxyalkanoate) copolymer (A1), and a poly(3-hydroxybutyrate) (A2). The amount of the polylactic acid resin (B) is from 20 to 65 wt % based on the total amount of the poly(3-hydroxyalkanoate) resin (A) and the polylactic acid resin (B). The amount of a fatty acid amide (C) is from 0 to less than 0.5 parts by weight per 100 parts by weight of the poly(3-hydroxyalkanoate) resin (A). The total proportion of the poly(3-hydroxyalkanoate) resin (A) and the polylactic acid resin (B) in the total amount of the resin composition for film molding, excluding any inorganic filler, is 98.5 wt % or more.

### TECHNICAL FIELD

One or more embodiments of the present invention relate to a resin composition for film molding that contains a poly(3-hydroxyalkanoate) resin, a film containing the composition, and a laminate containing the composition.

### BACKGROUND

In recent years, environmental challenges related to waste plastics have become an issue of great concern. In particular, waste plastics have caused serious marine pollution, and there is a demand for the widespread use of biodegradable plastics which are degradable in the natural environment.

Various such biodegradable plastics are known. Among them, poly(3-hydroxyalkanoate) resins (hereinafter also referred to as P3HA resins) are thermoplastic polyesters that are produced and accumulated as energy storage substances in the cells of many types of microorganisms. These resins are biodegradable in seawater as well as in soil, and are therefore attracting attention as materials that address the issues mentioned above.

However, P3HA resins are known to crystallize more slowly than common thermoplastic resins. Thus, when a P3HA resin is mixed with another resin and additives to prepare a resin compound, or when a P3HA resin is molded into a film, the P3HA resin does not readily solidify after thermal melting, which is disadvantageous.

To address the above, techniques are known in which the solidification properties of a P3HA resin are improved by adding a nucleating agent that accelerates crystallization of the P3HA resin. Fatty acid amides have been reported as an example of such nucleating agents (see Patent Literature 1, for example). In Examples of this literature, a fatty acid amide is added in an amount of 1 to 5 parts by weight per 100 parts by weight of a P3HA resin.

Patent Literature 2 is directed to a resin composition containing a P3HA resin in combination with another biodegradable resin, and teaches an example in which behenamide, which is a type of fatty acid amide, is incorporated as a lubricant into the resin composition. In this example, behenamide is added in an amount of 0.5 parts by weight per 100 parts by weight of the P3HA resin.

### PATENT LITERATURE

PTL 1: WO 2009/122673 A1
PTL 2: Japanese Laid-Open Patent Application Publication No. 2022-185793

When a blend of a P3HA resin with behenamide is molded into a film and the surface of the resulting film is printed, the printing ink may be repelled by the surface of the film. In addition, when aluminum or the like is vapor-deposited on the surface of the film, the adhesion of the vapor-deposited layer may be insufficient.

In an effort to address these issues, the present inventors succeeded in improving printability and vapor deposition properties by reducing the amount of the fatty acid amide as described in Patent Literature 1 or 2. However, reducing the amount of the fatty acid amide may retard solidification after thermal melting, thereby making compounding or film molding difficult or leading to a significant decline in productivity.

In view of the above circumstances, one or more embodiments of the present invention aim to provide a resin composition for film molding that contains a poly(3-hydroxyalkanoate) resin, the resin composition being adapted to achieve both good solidification properties after thermal melting and good printability and/or vapor deposition properties.

### SUMMARY

As a result of intensive studies, the present inventors have found that a poly(3-hydroxyalkanoate) resin-containing composition can achieve both good solidification properties after thermal melting and good printability and/or vapor deposition properties when the amount of a fatty acid amide added to the composition is reduced and a given amount of a polylactic acid resin is incorporated into the composition. Based on this finding, the inventors have completed one or more embodiments of the present invention.

Specifically, one or more embodiments of the present invention relate to a resin composition for film molding, containing:
a poly(3-hydroxyalkanoate) resin (A); and
a polylactic acid resin (B), wherein
an amount of the polylactic acid resin (B) is from 20 to 65 wt % based on a total amount of the poly(3-hydroxyalkanoate) resin (A) and the polylactic acid resin (B),
an amount of a fatty acid amide (C) is from 0 to less than 0.5 parts by weight per 100 parts by weight of the poly(3-hydroxyalkanoate) resin (A), and
a total proportion of the poly(3-hydroxyalkanoate) resin (A) and the polylactic acid resin (B) in a total amount of the resin composition for film molding, excluding any inorganic filler, is 98.5 wt % or more.

One or more embodiments of the present invention also relate to a film having the compositional makeup described above.

One or more embodiments of the present invention further relate to a laminate including: a first resin layer that is the film described above; and a second resin layer provided on the first resin layer.

One or more embodiments of the present invention can provide a resin composition for film molding that contains a poly(3-hydroxyalkanoate) resin, the resin composition being adapted to achieve both good solidification properties after thermal melting and good printability and/or vapor deposition properties.

According to an aspect of one or more embodiments of the present invention, the resin composition for film molding can be molded into a film through thermal melting, and the molding speed during this process can be increased.

According to an aspect of one or more embodiments of the present invention, the film can be stretched continuously and stably. Furthermore, a high-quality stretched film can be obtained at a high stretch ratio without uneven stretching.

According to an aspect of one or more embodiments of the present invention, a film having transparency can be obtained.

### DETAILED DESCRIPTION

Hereinafter, one or more embodiments of the present invention will be described. The present invention is not limited to one or more embodiments described below.

One or more embodiments relate to a resin composition for film molding that contains a poly(3-hydroxyalkanoate) resin (A) and a polylactic acid resin (B).

### [Poly(3-Hydroxyalkanoate) Resin (A)]

The poly(3-hydroxyalkanoate) resin (A) (hereinafter also referred to as the P3HA resin (A)) may be a single poly(3-hydroxyalkanoate) resin or a mixture of two or more poly(3-hydroxyalkanoate) resins. However, in order to reliably ensure high film strength and good film productivity, the P3HA resin (A) may be a mixture of at least two poly(3-hydroxyalkanoate) resins differing in the types and/or proportions of the constituent monomers.

The P3HA resin (A) is a polymer having 3-hydroxyalkanoate units. Specifically, the P3HA resin (A) may be a polymer containing units represented by the following formula (1).

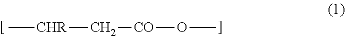

In the formula (1), R is an alkyl group represented by CₚH₂ₚ₊₁, and p is an integer from 1 to 15. Examples of R include linear or branched alkyl groups such as methyl, ethyl, propyl, methylpropyl, butyl, isobutyl, t-butyl, pentyl, and hexyl groups. The integer p may be from 1 to 10 or from 1 to 8.

The P3HA resin (A) may be a microbially produced poly(3-hydroxyalkanoate) resin. In microbially produced poly(3-hydroxyalkanoate) resins, all 3-hydroxyalkanoate units are contained as (R)-3-hydroxyalkanoate units.

The P3HA resin (A) may contain 50 mol % or more, 60 mol % or more, or 70 mol % or more, of 3-hydroxyalkanoate units (in particular, the units represented by the formula (1)) based on the total structural units. The P3HA resin (A) may contain only one type or two or more types of 3-hydroxyalkanoate units as polymer structural units, or may contain other units (such as 4-hydroxyalkanoate units) in addition to one type or two or more types of 3-hydroxyalkanoate units.

The P3HA resin (A) may be a homopolymer or a copolymer containing 3-hydroxybutyrate (hereinafter also referred to as 3HB) units. Such polymers may be hereinafter collectively referred to as “poly(3-hydroxybutyrate) resins.” In particular, all of the 3-hydroxybutyrate units may be (R)-3-hydroxybutyrate units. The P3HA resin (A) may include a copolymer of 3-hydroxybutyrate units and other hydroxyalkanoate units.

Specific examples of poly(3-hydroxybutyrate) resins include poly(3-hydroxybutyrate), poly(3-hydroxybutyrate-co-3-hydroxypropionate), poly(3-hydroxybutyrate-co-3-hydroxyvalerate) abbreviated as P3HB3HV, poly(3-hydroxybutyrate-co-3-hydroxyvalerate-co-3-hydroxyhexanoate), poly(3-hydroxybutyrate-co-3-hydroxyhexanoate) abbreviated as P3HB3HH, poly(3-hydroxybutyrate-co-3-hydroxyheptanoate), poly(3-hydroxybutyrate-co-3-hydroxyoctanoate), poly(3-hydroxybutyrate-co-3-hydroxynonanoate), poly(3-hydroxybutyrate-co-3-hydroxydecanoate), poly(3-hydroxybutyrate-co-3-hydroxyundecanoate), and poly(3-hydroxybutyrate-co-4-hydroxybutyrate) abbreviated as P3HB4HB. In particular, in terms of film productivity and film mechanical properties, poly(3-hydroxybutyrate-co-3-hydroxyhexanoate) or poly(3-hydroxybutyrate-co-4-hydroxybutyrate) may be used.

Poly(3-hydroxybutyrate-co-3-hydroxyhexanoate) may be used for the following reasons: its melting point and crystallinity can be changed by varying the proportions of the repeating units, and thus its physical properties such as Young's modulus and heat resistance can be adjusted and controlled to levels intermediate between those of polypropylene and polyethylene; and poly(3-hydroxybutyrate-co-3-hydroxyhexanoate) is a plastic that is easy to produce industrially and has useful physical properties. In particular, among poly(3-hydroxybutyrate) resins that are readily thermally decomposed when heated at 180° C. or higher, poly(3-hydroxybutyrate-co-3-hydroxyhexanoate) can have a low melting point and be moldable at low temperatures. Poly(3-hydroxybutyrate-co-3-hydroxyhexanoate) may be used also in this respect.

Examples of commercially available poly(3-hydroxybutyrate-co-3-hydroxyhexanoate) include “Kaneka Biodegradable Polymer Green Planet™” of Kaneka Corporation.

When the P3HA resin (A) contains a copolymer of 3-hydroxybutyrate units and other hydroxyalkanoate units, the average ratio between the 3-hydroxybutyrate units and the other hydroxyalkanoate units (3-hydroxybutyrate units/other hydroxyalkanoate units) in the total monomer units constituting the P3HA resin (A) may be from 99/1 to 80/20 (mol %/mol %), from 97/3 to 82/18 (mol %/mol %), or from 95/5 to 85/15 (mol %/mol %) in order to ensure both good strength of the resulting film and good film productivity.

The average ratio between different monomer units in the total monomer units constituting the P3HA resin (A) can be determined by a method known to those skilled in the art, such as the method described in paragraph of WO 2013/147139 A1. The term “average ratio” refers to the molar ratio between different monomer units in the total monomer units constituting the P3HA resin (A). When the P3HA resin (A) is a mixture of two or more poly(3-hydroxyalkanoate) resins, the average ratio refers to the molar ratio between different monomer units contained in the total mixture.

In order to reliably ensure both good solidification properties after thermal melting and high film strength, the P3HA resin (A) may contain at least a poly(3-hydroxyalkanoate) copolymer (A1). To further improve solidification properties after thermal melting, the P3HA resin (A) may contain a poly(3-hydroxybutyrate) (A2) in addition to the copolymer (A1). The following describes each of the polymers (A1) and (A2).

### [Poly(3-Hydroxyalkanoate) Copolymer (A1)]

The poly(3-hydroxyalkanoate) copolymer (A1) may be a copolymer of 3-hydroxybutyrate units and other hydroxyalkanoate units. In particular, in order to improve solidification properties after thermal melting, a copolymer may be used in which the proportion of the other hydroxyalkanoate units in the total amount of 3-hydroxybutyrate units and the other hydroxyalkanoate units is from 1 to less than 24 mol %.

In the copolymer (A1), the proportion of the other hydroxyalkanoate units may be from 3 to 20 mol %, from 4 to 17 mol %, or from 5 to 14 mol %.

The copolymer (A1) may be poly(3-hydroxybutyrate-co-3-hydroxyhexanoate) or poly(3-hydroxybutyrate-co-4-hydroxybutyrate), or poly(3-hydroxybutyrate-co-3-hydroxyhexanoate).

The weight-average molecular weight of the copolymer (A1) is not limited to a particular range. In terms of film strength, the weight-average molecular weight may be 20×10⁴ or more, 30×10⁴ or more, or 40×10⁴ or more. The upper limit of the weight-average molecular weight is not limited to a particular value. In terms of productivity, the weight-average molecular weight may be up to 200×10⁴, up to 150×10⁴, or up to 100×10⁴.

The weight-average molecular weight of a poly(3-hydroxyalkanoate) resin can be measured as a polystyrene-equivalent molecular weight by gel permeation chromatography (HPLC GPC system manufactured by Shimadzu Corporation) using a chloroform solution of the resin. The columns used in gel permeation chromatography may be any columns suitable for weight-average molecular weight measurement.

A copolymer (A1-1) that contains 3-hydroxybutyrate units and other hydroxyalkanoate units and in which the proportion of the other hydroxyalkanoate units is from 1 to less than 10 mol % may be used as the poly(3-hydroxyalkanoate) copolymer (A1). The use of such a copolymer makes it easier to ensure both high film strength and good solidification properties after thermal melting.

In the copolymer (A1-1), the proportion of the other hydroxyalkanoate units may be from 3 to 9 mol %, from 4 to 8 mol %, or from 5 to 7 mol %.

The copolymer (A1-1) may be poly(3-hydroxybutyrate-co-3-hydroxyhexanoate) or poly(3-hydroxybutyrate-co-4-hydroxybutyrate), or poly(3-hydroxybutyrate-co-3-hydroxyhexanoate).

The weight-average molecular weight of the copolymer (A1-1) is not limited to a particular range. In terms of film strength, the weight-average molecular weight may be 20×10⁴ or more, 30×10⁴ or more, or 40×10⁴ or more. The upper limit of the weight-average molecular weight is not limited to a particular value. In terms of productivity, the weight-average molecular weight may be up to 200×10⁴, up to 150×10⁴, or up to 100×10⁴.

The poly(3-hydroxyalkanoate) copolymer (A1) may consist solely of the copolymer (A1-1). Alternatively, the poly(3-hydroxyalkanoate) copolymer (A1) may further include, in addition to the copolymer (A1-1), a copolymer (A1-2) that contains 3-hydroxybutyrate units and other hydroxyalkanoate units and in which the proportion of the other hydroxyalkanoate units is from 10 to less than 24 mol %. The use of the copolymers (A1-1) and (A1-2) in combination can further enhance the strength of the film.

In the copolymer (A1-2), the proportion of the other hydroxyalkanoate units may be from 10 to 20 mol %, from 10 to 17 mol %, or from 10 to 14 mol %.

The copolymer (A1-2) may be poly(3-hydroxybutyrate-co-3-hydroxyhexanoate) or poly(3-hydroxybutyrate-co-4-hydroxybutyrate), or poly(3-hydroxybutyrate-co-3-hydroxyhexanoate).

The weight-average molecular weight of the copolymer (A1-2) is not limited to a particular range. In terms of film strength, the weight-average molecular weight may be 20×10⁴ or more, 30×10⁴ or more, or 40×10⁴ or more. The upper limit of the weight-average molecular weight is not limited to a particular value. In terms of productivity, the weight-average molecular weight may be up to 200×10⁴, up to 150×10⁴, or up to 100×10⁴.

When the copolymer (A1) includes the copolymers (A1-1) and (A1-2), the weight ratio between the copolymers (A1-1) and (A1-2) (A1-1/A1-2) may be from 40/60 to 99/1, from 60/40 to 97/3, or from 80/20 to 95/5 in order to take advantage of the properties of the two copolymers.

The copolymer (A1) may consist solely of the copolymer (A1-1) or may consist solely of the copolymers (A1-1) and (A1-2). Alternatively, the copolymer (A1) may further contain a poly(3-hydroxyalkanoate) copolymer that is classified neither as the copolymer (A1-1) nor as the copolymer (A1-2). Examples of such poly(3-hydroxyalkanoate) copolymers include a copolymer that contains 3-hydroxybutyrate units and other hydroxyalkanoate units and in which the proportion of the other hydroxyalkanoate units is 24 mol % or more.

The total proportion of the copolymers (A1-1) and (A1-2) in the total amount of the copolymer (A1) may be, for example, from 70 to 100 wt %, from 80 to 100 wt %, or from 90 to 100 wt %.

### [Poly(3-Hydroxybutyrate) (A2)]

The resin composition for film molding according to one or more embodiments may contain a poly(3-hydroxybutyrate) (A2) in addition to the poly(3-hydroxyalkanoate) copolymer (A1) described above. The poly(3-hydroxybutyrate) (A2) exhibits higher crystallinity and solidifies more readily than the copolymer (A1). Accordingly, the incorporation of the poly(3-hydroxybutyrate) (A2) can further improve solidification properties after thermal melting.

The term “poly(3-hydroxybutyrate) (A2)” refers to a homopolymer of 3-hydroxybutyrate or a polymer containing 3-hydroxybutyrate units and further containing a small amount of other hydroxyalkanoate units. Specifically, in the poly(3-hydroxybutyrate) (A2), the proportion of 3-hydroxybutyrate units in the total constituent monomer units may be more than 99 mol % and up to 100 mol %.

The hydroxyalkanoate units other than 3-hydroxybutyrate units that may be contained in the poly(3-hydroxybutyrate) (A2) are not limited to a particular type, and may be any hydroxyalkanoate units copolymerizable with 3-hydroxybutyrate units. Examples include 3-hydroxyalkanoate units other than 3-hydroxybutyrate units and hydroxyalkanoate units other than 3-hydroxyalkanoate units (e.g., 4-hydroxyalkanoate units). In particular, 3-hydroxyhexanoate units may be used.

The weight-average molecular weight of the poly(3-hydroxybutyrate) (A2) is not limited to a particular range. In terms of film strength and solidification properties, the weight-average molecular weight may be from 20×10⁴ to 200×10⁴ or from 30×10⁴ to 150×10⁴. The weight-average molecular weight can be measured by the method described above.

In the resin composition for film molding according to one or more embodiments, the proportion of the poly(3-hydroxybutyrate) (A2) in the total weight of the poly(3-hydroxyalkanoate) copolymer (A1) and the poly(3-hydroxybutyrate) (A2) may be 1 wt % or more, 3 wt % or more, or 5 wt % or more in order to improve solidification properties through incorporation of the poly(3-hydroxybutyrate) (A2). In terms of film strength, the proportion may be up to 50 wt %, up to 40 wt %, up to 30 wt %, up to 25 wt %, or up to 20 wt %.

The total proportion of the copolymer (A1) and the poly(3-hydroxybutyrate) (A2) in the total amount of the P3HA resin (A) may be, for example, from 70 to 100 wt %, from 80 to 100 wt %, or from 90 to 100 wt %.

The method used to obtain a blend of two or more poly(3-hydroxyalkanoate) resins is not limited to a particular technique. A blend of two or more poly(3-hydroxyalkanoate) resins may be obtained by microbial production or chemical synthesis. Alternatively, a blend of two or more resins may be obtained by melting and kneading the resins using a device such as an extruder, a kneader, a Banbury mixer, or a roll mill, or may be obtained by dissolving and mixing the resins in a solvent and drying the resulting mixture.

The weight-average molecular weight of the total P3HA resin (A) is not limited to a particular range. In terms of film strength and film productivity, the weight-average molecular weight may be from 20×10⁴ to 200×10⁴, from 30×10⁴ to 150×10⁴, or from 40×10⁴ to 100×10⁴.

The method used to produce poly(3-hydroxyalkanoate) resins is not limited to a particular technique, and may be a production method using chemical synthesis or a microbial production method. A microbial production method may be used. The microbial production method used can be any known method. Known examples of bacteria that produce copolymers of 3-hydroxybutyrate with other hydroxyalkanoates include Aeromonas caviae which is a P3HB3HV- and P3HB3HH-producing bacterium and Alcaligenes eutrophus which is a P3HB4HB-producing bacterium. In particular, in order to increase P3HB3HH productivity, Alcaligenes eutrophus AC32 (FERM BP-6038; see T. Fukui, Y. Doi, J. Bacteriol., 179, pp. 4821-4830 (1997)) incorporating a P3HA synthase gene may be used. Such a microorganism is cultured under suitable conditions to allow the microorganism to accumulate P3HB3HH in its cells, and the microbial cells accumulating P3HB3HH are used. Instead of the above microorganisms, a genetically modified microorganism incorporating any suitable poly(3-hydroxyalkanoate) resin synthesis-related gene may be used depending on the poly(3-hydroxyalkanoate) resin to be produced. The culture conditions including the type of the substrate may be optimized depending on the poly(3-hydroxyalkanoate) resin to be produced.

An unmodified poly(3-hydroxyalkanoate) resin can be used as the P3HA resin (A). Alternatively, a resin obtained by modifying an unmodified poly(3-hydroxyalkanoate) resin with a resin-reactive material such as a peroxide (hereinafter referred to as a “modifying material”) may be used.

The modifying material is not limited to a particular compound, and may be any compound reactive with poly(3-hydroxyalkanoate) resins. In terms of handleability and ease of control of the reaction with poly(3-hydroxyalkanoate) resins, an organic peroxide may be used. The organic compound used may be any suitable known compound.

### [Polylactic Acid Resin (B)]

The polylactic acid resin (B) is a polyester containing lactic acid as a constituent monomer. While poly(3-hydroxyalkanoate) resins have a glass transition temperature of around 0° C., polylactic acid resins generally have a glass transition temperature of around 60° C. and can thus solidify at a temperature lower than 60° C. Accordingly, the incorporation of the polylactic acid resin (B) can improve the solidification properties of the poly(3-hydroxyalkanoate) resin-containing composition.

Generally, polylactic acid resins have a glass transition temperature of around 60° C. and, when rapidly cooled from a molten state, they do not readily crystallize but become amorphous. Thus, the incorporation of the polylactic acid resin (B) into a film facilitates softening of the film even at a relatively low temperature slightly above 60° C. Accordingly, the incorporation of the polylactic acid resin (B) into a poly(3-hydroxyalkanoate) resin-containing film can enhance the stretchability of the film. This makes it possible to prevent film breakage during stretching and obtain a high-quality stretched film without uneven stretching. In addition, film stretching can be carried out continuously and stably. Furthermore, high stretch ratios can be achieved.

The polylactic acid resin (B) may be a homopolymer of lactic acid, but may contain a small amount of a monomer other than lactic acid.

The lactic acid of the polylactic acid resin (B) may be either L-lactic acid or D-lactic acid or may be a combination of both. In the latter case, the ratio between L-lactic acid and D-lactic acid is not limited to a particular range.

The polylactic acid resin (B) may be a poly(L-lactic acid) resin, a poly(D-lactic acid) resin, or a poly(DL-lactic acid) resin. A blend of these resins may be used.

Examples of the other monomer that may be contained in the polylactic acid resin (B) include aliphatic hydroxycarboxylic acids other than lactic acid, aliphatic polyhydric alcohols, aliphatic polycarboxylic acids, and polyfunctional polysaccharides.

When the polylactic acid resin (B) is a copolymer of lactic acid and another monomer, the proportion of the other monomer in the total monomers contained in the polylactic acid resin (B) may be from about 0 to about 3 mol %, in terms of crystallinity. The proportion may be from 0 to 2 mol %.

The polylactic acid resin (B) may be either a crystalline polylactic acid resin or an amorphous polylactic acid resin. In terms of heat resistance against thermal shrinkage during a post-process such as printing or vapor deposition, a crystalline polylactic acid resin may be used. Among crystalline polylactic acid resins, a polylactic acid resin that exhibits a melting point peak with a peak temperature below 170° C. in differential scanning calorimetry may be used.

The peak temperature of the melting point peak of the polylactic acid resin (B) (hereinafter also referred to as the “melting point peak temperature” or “melting point”) may be 165° C. or lower or 160° C. or lower in order to increase film productivity and enhance the stretchability and strength of the film. The peak temperature may be lower than 160° C. or 155° C. or lower. The peak temperature may be at least 120° C., at least 130° C., or at least 140° C. in order to enhance film productivity and film stretchability.

The “melting point peak temperature” refers to a peak top temperature Tm of a crystalline melting peak on a DSC curve obtained by differential scanning calorimetry (DSC). The DSC curve is obtained by weighing about 5 mg of the resin to be analyzed and heating the weighed resin from 0 to 200° C. at a rate of 10° C./min in a differential scanning calorimeter.

The polylactic acid resin (B) which exhibits a melting point peak temperature as described above is not limited to a particular resin and may be a commercially available product. Specific examples include polylactic acid resins in which L-lactic acid constitutes 88 to 98% of the lactic acid units.

In order to enhance film productivity and film stretchability, the melting point peak temperature exhibited by the polylactic acid resin (B) may be close to a melting point peak temperature exhibited by the P3HA resin (A). Specifically, the absolute value of the difference between the melting point peak temperature of the polylactic acid resin (B) and the melting point peak temperature of the P3HA resin (A) may be 40° C. or less, 30° C. or less, or 20° C. or less.

The melting point peak temperature of the P3HA resin (A) is measured in the same manner as that of the polylactic acid resin (B). When a plurality of melting point peaks appear on a DSC curve obtained for the P3HA resin (A), the peak temperature of the melting point peak that exists in a higher temperature range than the other melting point peaks is determined as the melting point peak temperature of the P3HA resin (A).

The molecular weight of the polylactic acid resin (B) is not limited to a particular range and may be set as appropriate. The number-average molecular weight may be from 1×10³ to 70×10⁴ or from 1×10⁴ to 30×10⁴.

The lactic acid material used to produce the polylactic acid resin (B) is not limited to a particular type; L-lactic acid, D-lactic acid, DL-lactic acid, or a mixture thereof may be used. Alternatively, L-lactide, D-lactide, meso-lactide, or a mixture thereof may also be used. Lactic acid obtained by microbial fermentation of a plant-derived renewable material such as starch can be suitably used.

The method for producing the polylactic acid resin (B) is not limited to a particular technique and may be any known method such as dehydration polycondensation or ring-opening polymerization.

In the resin composition for film molding according to one or more embodiments, the amount of the polylactic acid resin (B) is from 20 to 65 wt % based on the total amount of the P3HA resin (A) and the polylactic acid resin (B). By incorporating the polylactic acid resin (B) in an amount of 20 wt % or more, good solidification properties after thermal melting can be achieved despite the small amount of a fatty acid amide (C) used as a component to improve solidification properties. In order to further improve solidification properties and enhance film stretchability, the amount of the polylactic acid resin (B) may be 25 wt % or more, 30 wt % or more, or 35 wt % or more. The amount of the polylactic acid resin (B) may be 40 wt % or more, 45 wt % or more, 50 wt % or more, or 55 wt % or more.

Limiting the amount of the polylactic acid resin (B) to 65 wt % or less can enhance the biodegradability (in particular, biodegradability in composting and marine degradability) of the resin composition for film molding and the resulting film. The amount of the polylactic acid resin (B) may be 60 wt % or less, 50 wt % or less, or 45 wt % or less.

The resin composition for film molding according to one or more embodiments is a resin film primarily composed of the P3HA resin (A) and the polylactic acid resin (B). Specifically, the total proportion of the P3HA resin (A) and the polylactic acid resin (B) in the total amount of the resin composition for film molding, excluding any inorganic filler, is 98.5 wt % or more. Accordingly, the biodegradability of the resin composition for film molding and the resulting film can be enhanced. In addition, the amount of any component that can cause deterioration in printability and/or vapor deposition properties can be reduced, so that printability and/or vapor deposition properties on the film surface can be improved.

The total proportion of the P3HA resin (A) and the polylactic acid resin (B) may be 99.0 wt % or more, 99.5 wt % or more, or 99.9 wt % or more. The total proportion may be 100 wt %. As used herein, the term “total proportion of the resins (A) and (B)” refers to the total proportion of the two resins in the total amount of the resin composition for film molding when the resin composition for film molding does not contain any inorganic filler. When the resin composition for film molding contains an inorganic filler, the term refers to the total proportion of the two resins in the total amount of the resin composition excluding the inorganic filler. As used herein, the term “inorganic filler” is intended to include a layered clay mineral (D) described later and an inorganic filler not classified as the component (D) (examples include silica compounds such as crystalline silica, molten silica, and amorphous silica and metal salt compounds such as calcium carbonate, magnesium carbonate, and barium sulfate).

### [Fatty Acid Amide (C)]

In the resin composition for film molding according to one or more embodiments, the amount of a fatty acid amide (C), which is known to function as a nucleating agent for poly(3-hydroxyalkanoate) resins, is reduced. Accordingly, printability and/or vapor deposition properties on the film surface can be improved.

The resin composition for film molding according to one or more embodiments contains the polylactic acid resin (B) in a given amount. Accordingly, despite the small amount of the fatty acid amide (C), solidification after thermal melting is accelerated, and the time required for compounding or film molding can be shortened.

Examples of the fatty acid amide (C) include behenamide, oleamide, erucamide, stearamide, palmitamide, N-stearyl behenamide, N-stearyl erucamide, ethylene bis(stearamide), ethylene bis(oleamide), ethylene bis(erucamide), ethylene bis(lauramide), ethylene bis(capramide), p-phenylene bis(stearamide), and a polycondensation product of ethylenediamine, stearic acid, and sebacic acid. Behenamide and/or erucamide may be used as the fatty acid amide (C) because these compounds have a particularly superior solidification-accelerating effect. One fatty acid amide (C) may be used, or two or more fatty acid amides (C) may be used. The proportions of the fatty acid amides used can be adjusted as appropriate depending on the intended purpose.

In the resin composition for film molding according to one or more embodiments, the amount of the fatty acid amide (C) is from 0 to less than 0.5 parts by weight per 100 parts by weight of the P3HA resin (A). The smaller the amount of the fatty acid amide (C), the better printability and/or vapor deposition properties can be. The amount of the fatty acid amide (C) may be less than 0.3 parts by weight, less than 0.2 parts by weight, or less than 0.1 parts by weight.

In particular, in order to further improve printability and/or vapor deposition properties, the resin composition for film molding according to one or more embodiments may be substantially free of the fatty acid amide (C). The expression “substantially free of the fatty acid amide (C)” means that the amount of the fatty acid amide (C) is so small that the fatty acid amide (C) cannot be considered to function as a nucleating agent for the P3HA resin (A), or that the amount of the fatty acid amide (C) is zero. A specific range of such a small amount of the fatty acid amide (C) is, for example, from 0 to less than 0.1 parts by weight per 100 parts by weight of the total amount of the P3HA resin (A). The amount of the fatty acid amide (C) may be less than 0.05 parts by weight or may be less than 0.01 parts by weight. The amount of the fatty acid amide (C) may be zero.

### [Layered Clay Mineral (D)]

The resin composition for film molding according to one or more embodiments may further contain a layered clay mineral (D). In this case, solidification properties after thermal melting are further improved, and the time required for compounding or film molding can be further shortened.

The term “layered clay mineral” refers to a mineral containing a layered silicate as a main component.

The layered clay mineral (D) is not limited to a particular material, and any known layered clay mineral may be used. To reliably achieve the improvement effect on solidification properties, at least one layered clay mineral may be selected from the group consisting of smectite, mica, talc, pyrophyllite, vermiculite, chlorite, kaolinite, and serpentine. In terms of utility, mica, talc, and kaolinite may be used. Particularly, talc may be used.

Examples of the mica include wet-ground mica and dry-ground mica.

Examples of the talc include general-purpose talc and surface-treated talc.

Examples of the kaolinite include dry kaolin, calcined kaolin, and wet kaolin.

The amount of the layered clay mineral (D) is not limited to a particular range. In order to improve solidification properties after thermal melting, the amount of the layered clay mineral (D) may be 0.1 parts by weight or more, 0.5 parts by weight or more, or 1 part by weight or more per 100 parts by weight of the P3HA resin (A). In order to improve printability and/or vapor deposition properties and/or to enhance film transparency, the amount of the layered clay mineral (D) may be 8 parts by weight or less, 5 parts by weight or less, 4 parts by weight or less, or 3 parts by weight or less per 100 parts by weight of the P3HA resin (A).

### (Nucleating Agent)

The resin composition for film molding according to one or more embodiments may contain a nucleating agent. Examples of nucleating agents include: sugar alcohols such as pentaerythritol, galactitol, and mannitol; orotic acid; aspartame; cyanuric acid; glycine; zinc phenylphosphonate; and boron nitride. Among these, sugar alcohols may be used because they are particularly effective in accelerating the crystallization of the P3HA resin (A). Pentaerythritol may be used. One nucleating agent may be used, or two or more nucleating agents may be used. The proportions of the nucleating agents used can be adjusted as appropriate depending on the intended purpose.

When a nucleating agent is used, the amount of the nucleating agent is not limited to a particular range. In terms of the balance between the crystallization-accelerating effect and the improvement in printability and/or vapor deposition properties, the amount of the nucleating agent may be from 0.1 to 1.5 parts by weight or from 0.5 to 1.0 parts by weight per 100 parts by weight of the P3HA resin (A).

However, the resin composition for molding according to one or more embodiments may be substantially free of any sugar alcohol such as pentaerythritol. In an aspect where the resin composition is substantially free of any sugar alcohol, an undesired phenomenon can be avoided in which a sugar alcohol bleeds out from the molten resin material and soils the surface of a production device (for example, the surface of a cast roll) with which the resin composition comes into contact. In addition, printability and/or vapor deposition properties on the film surface can be further improved.

The resin composition for film molding according to one or more embodiments contains the polylactic acid resin (B) in a given amount. Accordingly, even when the resin composition is substantially free of any sugar alcohol, solidification after thermal melting is accelerated, and the time required for compounding or film molding can be shortened.

The expression “substantially free of any sugar alcohol” means that the amount of sugar alcohols is so small that they cannot be considered to function as a nucleating agent for the P3HA resin (A), or that the amount of sugar alcohols is zero. A specific range of such an small amount of sugar alcohols is, for example, from 0 to less than 0.1 parts by weight per 100 parts by weight of the total amount of the P3HA resin (A). The amount of sugar alcohols may be less than 0.05 parts by weight or may be less than 0.01 parts by weight. The amount of sugar alcohols may be zero.

Such sugar alcohols may be compounds known as nucleating agents for poly(3-hydroxyalkanoate) resins. Specific examples other than pentaerythritol include erythritol, D-arabitol, ribitol, xylitol, galactitol, D-mannitol, L-mannitol, D-sorbitol, myo-inositol, scyllo-inositol, maltitol, and lactitol. In particular, the resin composition may be substantially free of pentaerythritol.

### (Additional Resin)

The resin composition for film molding according to one or more embodiments may contain an additional resin other than the P3HA resin (A) and the polylactic acid resin (B), to the extent that the additional resin does not diminish the effect of one or more embodiments of the invention. Examples of such additional resins include: aliphatic polyester resins such as polybutylene succinate adipate, polybutylene succinate, and polycaprolactone; and aliphatic-aromatic polyester resins such as polybutylene adipate terephthalate, polybutylene sebacate terephthalate, and polybutylene azelate terephthalate. The resin composition may contain only one additional resin or may contain two or more additional resins.

The amount of the additional resin is not limited to a particular range, but may be 1.5 parts by weight or less, 1.0 parts by weight or less, 0.5 parts by weight or less, or 0.1 parts by weight or less per 100 parts by weight of the total amount of the P3HA resin (A) and the polylactic acid resin (B). The lower limit of the amount of the additional resin is not limited to a particular value and may be 0 parts by weight.

The resin composition for film molding according to one or more embodiments may contain additives that can be used with the P3HA resin (A) and the polylactic acid resin (B), to the extent that the additives do not diminish the effect of one or more embodiments of the invention. Examples of such additives include: colorants such as pigments and dyes; odor absorbers such as activated carbon and zeolite; flavors such as vanillin and dextrin; and various other additives such as fillers, plasticizers, oxidation inhibitors, antioxidants, weathering resistance improvers, ultraviolet absorbers, mold release agents, water-repellent agents, anti-microbial agents, and slidability improvers. The resin composition may contain only one additive or may contain two or more additives. The amounts of such additives can be set by those skilled in the art as appropriate depending on the intended purpose.

The following describes fillers and plasticizers in detail.

### (Filler)

The resin composition for film molding according to one or more embodiments may contain a filler. The inclusion of a filler can increase the strength of the resulting film. The filler may be an inorganic filler, an organic filler, or a combination of both. The inorganic filler may be any inorganic filler that is not classified as the layered clay mineral (D) described above. Examples include silicate salts, carbonate salts, sulfate salts, phosphate salts, oxides, hydroxides, nitrides, and carbon black. One inorganic filler may be used alone, or two or more inorganic fillers may be used in combination.

When a filler other than the layered clay mineral (D) is used, the amount of the filler is not limited to a particular range, but may be from 1 to 100 parts by weight, from 3 to 80 parts by weight, from 5 to 70 parts by weight, or from 10 to 60 parts by weight per 100 parts by weight of the total amount of the P3HA resin (A) and the polylactic acid resin (B).

However, in order to improve printability and/or vapor deposition properties, the resin composition for film molding according to one or more embodiments may be substantially free of any filler other than the layered clay mineral (D). The expression “substantially free of any filler other than the layered clay mineral (D)” means that the amount of any filler other than the layered clay mineral (D) is less than 1 part by weight per 100 parts by weight of the total amount of the P3HA resin (A) and the polylactic acid resin (B). The amount of such a filler may be less than 0.5 parts by weight or less than 0.1 parts by weight.

### (Plasticizer)

The resin composition for film molding according to one or more embodiments may contain a plasticizer. Examples of plasticizers include glycerin ester compounds, citric ester compounds, sebacic ester compounds, adipic ester compounds, polyether ester compounds, benzoic ester compounds, phthalic ester compounds, isosorbide ester compounds, polycaprolactone compounds, and dibasic ester compounds. Among these, glycerin ester compounds, citric ester compounds, sebacic ester compounds, and dibasic ester compounds may be used because they are particularly effective in plasticizing the P3HA resin (A). Examples of glycerin ester compounds include glycerin diacetomonolaurate. Examples of citric ester compounds include tributyl acetylcitrate. Examples of sebacic ester compounds include dibutyl sebacate. Examples of dibasic ester compounds include benzyl methyl diethylene glycol adipate. One plasticizer may be used, or two or more plasticizers may be used. The proportions of the plasticizers used can be adjusted as appropriate depending on the intended purpose.

When a plasticizer is used, the amount of the plasticizer is not limited to a particular range, but may be from 0.1 to 1.5 parts by weight or from 0.5 to 1.0 parts by weight per 100 parts by weight of the total amount of the P3HA resin (A) and the polylactic acid resin (B). However, in order to improve printability and/or vapor deposition properties, the resin composition for film molding according to one or more embodiments may be substantially free of any plasticizer. The expression “substantially free of any plasticizer” means that the amount of plasticizers is less than 1 part by weight per 100 parts by weight of the total amount of the P3HA resin (A) and the polylactic acid resin (B). The amount of plasticizers may be less than 0.5 parts by weight or less than 0.1 parts by weight.

The resin composition for film molding according to one or more embodiments can be, but is not limited to being, produced by mixing the P3HA resin (A), the polylactic acid resin (B), and optionally other components using ordinary means and then melting and kneading the mixture. The melting and kneading can be carried out using a kneading device such as a single-screw or twin-screw extruder, a Banbury mixer, a pressure kneader, or a mixing roll. Through such melting and kneading, pellets made of the resin composition for film molding can be produced. However, the form of the resin composition for film molding is not limited to pellets.

According to one or more embodiments, the incorporation of a given amount of the polylactic acid resin (B) enables shortening of the time required for production of the resin composition for film molding, i.e., for compounding.

### [Film]

One aspect of one or more embodiments relates to a film. The film according to one or more embodiments can be produced with good productivity by virtue of the incorporation of a given amount of the polylactic acid resin (B).

The compositional makeup of the film will not be described in detail, as it falls within the scope of the compositional makeup described above for the resin composition for film molding according to one or more embodiments. In this aspect related to the film, the term “total amount of the resin composition for film molding, excluding any inorganic filler” is to be understood interchangeably with “total weight of the film, excluding any inorganic filler.”

The film according to one or more embodiments may be produced using the resin composition for film molding described above, or may be directly produced, without using the composition, by mixing the components of the composition and melting the resulting mixture. Alternatively, other components may be added to the resin composition for film molding described above, and the resulting mixture may be used to produce the film.

The film may be an unstretched film that has not been subjected to stretching, or may be a stretched film that has been stretched in the MD direction and/or the TD direction after film molding. As used herein, the term “film” is intended to encompass both unstretched and stretched films. In terms of strength, the film may be a stretched film.

In terms of thickness uniformity, appearance, strength, and low weight, the thickness of the film (in particular, a stretched film) according to one or more embodiments may be from 10 to 200 μm, from 15 to 150 μm, or from 20 to 100 μm.

The film according to one or more embodiments may be an industrially produced long film, or a strip-shaped film wound into a roll. The length of such a film is not limited to a particular range, and may be, for example, 50 m or more or 100 m or more. In one or more embodiments, such a long film can be produced continuously and stably.

The film according to one or more embodiments may be transparent so that, for example, when the film is used for packaging, the packaged product can be visually recognized. From this perspective, the haze value exhibited by the film according to one or more embodiments may be 70% or less, 60% or less, 50% or less, or 40% or less. As described later, the haze value refers to a parameter measured according to JIS K 7136-1:1999 and K 7316:2000.

Since the film according to one or more embodiments exhibits good printability and vapor deposition properties, a vapor-deposited layer or a printed layer can be provided directly on the surface of the film. Accordingly, the film according to one or more embodiments can be suitably used as a film for vapor-deposited layer formation or printed layer formation. The film according to one or more embodiments may include a vapor-deposited layer or a printed layer on at least a portion of its surface. The details of such a vapor-deposited layer or printed layer will be described later.

### [Method for Producing Film]

Next, an example of a method for producing the film according to one or more embodiments will be described. One or more embodiments of the present invention are not limited by the following description.

The film molding method is not limited to a particular technique. A molten film raw material may be extruded through a T-die; that is, extrusion molding may be used. By extrusion molding, a film having a uniform thickness can easily be produced. The extrusion molding can be carried out using any suitable means such as a single-screw or twin-screw extruder.

When the resin composition for film molding according to one or more embodiments is fed into an extruder, other components may also be fed together with the resin composition. Examples of such other components include additives for resins, and polylactic acid resins. It should be understood that the amounts of the other components are set such that the compositional makeup of the resulting blend containing these components falls within the scope of the compositional makeup described above for the resin composition for film molding.

In particular, when the amount of the polylactic acid resin (B) contained in the resin composition for film molding according to one or more embodiments is relatively small, the polylactic acid resin (B) may be additionally added to the resin composition for film molding according to one or more embodiments to increase the amount of the polylactic acid resin (B) in the film. This is done to improve productivity during film molding and enhance the stretchability of the film. In this case, the resin composition for film molding and the polylactic acid resin (B) may be dry-blended before being fed into the extruder. It should be understood that the amount of the polylactic acid resin (B) additionally added is set such that the final amount of the polylactic acid resin (B) in the film falls within the range described above for the amount of the polylactic acid resin (B) in the resin composition for film molding.

The melting of the film raw material may be performed under any conditions that allow the P3HA resin (A) and the polylactic acid resin (B) to melt. The temperature of the molten film raw material may be, for example, from about 140 to about 210° C.

Next, the molten film raw material is extruded onto a cast roll to mold the material into a film. The melt of the film raw material comes into contact with the cast roll and moves along the surface of the cast roll, thus becoming cooled and solidified. In one or more embodiments, since the polylactic acid resin (B) is incorporated in a given amount, the time required for solidification on the cast roll can be shortened despite the reduced amount of the fatty acid amide (C). As a result, the film production speed can be increased.

This step may involve extruding the melt onto a single cast roll or onto a plurality of cast rolls, or may involve placing a touch roll facing a cast roll and pressing the melt extruded onto the cast roll between the touch roll and the cast roll.

An air knife or an air chamber may be used to ensure stable contact of the melt with the cast roll. The cast roll may be placed in a water bath, or an air chamber may be used, to efficiently cool the side of the melt opposite the side in contact with the cast roll.

The set temperature of the cast roll may be at least 0° C., at least 10° C., or at least 15° C. in order to reduce the tackiness of the P3HA resin (A) and improve the separability of the film from the cast roll. The set temperature of the cast roll may be higher than a temperature that is 10° C. above the glass transition temperature (Tg) of the P3HA resin (A).

The upper limit of the set temperature of the cast roll is not limited to a particular value. In order to accelerate the solidification of the P3HA resin (A), the set temperature may be up to 80° C. or up to 60° C.

Next, the film cooled on the cast roll is transferred as the cast roll rotates, thereby separating the film from the cast roll. As a result, an unstretched film can be obtained.

The obtained film may be subsequently stretched in the MD direction to obtain a uniaxially stretched film having high strength in the MD direction. The MD direction is also referred to as the machine direction, flow direction, or longitudinal direction. The TD direction described later is a direction perpendicular to the MD direction, and is also referred to as the transverse direction or width direction.

The MD-direction stretching step can be performed directly after separation from the cast roll on the same production line. This step is not limited to using a particular technique, and can be performed, for example, by using a roll longitudinal stretching machine including a plurality of rolls over which the film is transferred, with the plurality of rolls operated at different rotational speeds.

During the MD-direction stretching step, the film may be heated. The heating is not limited to using a particular technique, and examples of heating techniques include: a technique in which an air stream adjusted to a given temperature is applied to the film; a technique in which the film temperature is controlled by setting rolls to a given temperature; a technique in which the film temperature is controlled to a given temperature by heating the film using auxiliary heating means such as an IR heater; and a technique in which the film is passed through an oven adjusted to a given temperature. One of these techniques may be used alone, or two or more thereof may be used in combination.

In the film production according to one or more embodiments, the temperature during MD-direction stretching may be 35° C. or higher, 45° C. or higher, or 55° C. or higher. Generally, polylactic acid resins have a glass transition temperature of around 60° C. and, when rapidly cooled from a molten state, they do not readily crystallize but become amorphous. Thus, the film according to one or more embodiments can readily soften even at a temperature below the melting point of the poly(3-hydroxyalkanoate) resin, and successful stretching can be achieved. In addition, the temperature during stretching can easily be controlled and stabilized. Accordingly, film stretching can be carried out continuously and stably, so that a long stretched film can be produced stably.

The upper limit of the temperature during MD-direction stretching is not limited to a particular value. In order to avoid breakage of the film during stretching, the temperature may be up to 110° C., up to 100° C., or up to 90° C.

The stretch ratio in the MD direction is not limited to a particular range, but may be 2 or more. The stretch ratio may be 2.5 or more or 3 or more. Such a high stretch ratio can be achieved by virtue of the compositional makeup of the film raw material according to one or more embodiments. The upper limit of the stretch ratio is not limited to a particular value, and may be chosen as appropriate. For example, the stretch ratio may be up to 8.

The MD-direction stretching may be followed by stretching in the TD direction to obtain a biaxially stretched film having high strength in both the MD and TD directions. The TD-direction stretching step can be carried out directly after the MD-direction stretching step on the same production line. This step is not limited to using a particular technique, and can be performed, for example, by using a transverse stretching machine such as a clip tenter to clamp the film at both width ends and pull the clamped film in the TD direction.

The film may be heated during the TD-direction stretching step as well. The heating is not limited to using a particular technique, and any of the heating techniques described above for the MD-direction stretching step may be used.

The temperature during TD-direction stretching may be set similarly to the temperature during MD-direction stretching, and may be from 35 to 110° C., from 45 to 100° C., or from 55 to 90° C.

The stretch ratio in the TD direction is not limited to a particular range, but may be 2 or more. The stretch ratio may be 3 or more or 4 or more. Such a high stretch ratio can be achieved by virtue of the compositional makeup of the film raw material according to one or more embodiments. The upper limit of the stretch ratio is not limited to a particular value and may be chosen as appropriate. For example, the stretch ratio may be up to 8.

After the MD-direction or TD-direction stretching step, a heat setting step in which the stretched film is heated to a temperature that allows high-melting-point crystals to grow may be performed. This step can increase the crystallinity and hence the strength of the stretched film, and can also stabilize the physical properties of the stretched film.

The heating temperature during the heat setting may be from 80 to 150° C., from 90 to 135° C., or from 100 to 130° C. When the heating temperature is 80° C. or higher, the crystallinity of the stretched film increases, and the formed crystals can have a high melting point. When the heating temperature is 150° C. or lower, film breakage due to melting can be avoided.

The heat setting can be carried out, for example, by heating the stretched film while maintaining its stretched state after TD-direction stretching performed using a transverse stretching machine such as a clip tenter. During this step, since the film attempts to thermally shrink in a direction opposite to the stretch direction, relaxation may be performed to prevent breakage of the film. The relaxation is a procedure that allows the film to retract in the direction opposite to the stretch direction. The amount of relaxation may be adjusted as appropriate between 5% and 30%.

Subsequently, the step of cooling the film may be performed as appropriate. Subsequently, the step of winding the stretched film onto a take-up roll may be performed.

In the film production method according to one or more embodiments, the film may be transferred continuously throughout all steps from melt extrusion to the final step. In this case, film production with good productivity can be accomplished by an industrially simple process. The production method according to one or more embodiments can be carried out while continuously winding the produced film onto a take-up roll.

When the stretched film is continuously transferred, the transfer speed is not limited to a particular range. In terms of film productivity, the transfer speed may be 5 m/min or higher or 15 m/min or higher before the start of stretching. In terms of production stability, the transfer speed may be 50 m/min or lower before the start of stretching.

### [Laminate]

The film according to one or more embodiments may be a resin film consisting of a single self-supporting layer. Alternatively, a laminate may be formed by placing at least one other layer on one or both sides of the film (hereinafter also referred to as the first resin layer). Such a laminate is also one aspect of one or more embodiments of the present invention.

One example of the other layer is a second resin layer.

The resin used to form the second resin layer is not limited to a particular type. In order to enhance the biodegradability of the entire laminate, the second resin layer may contain a poly(3-hydroxyalkanoate) resin (E). The poly(3-hydroxyalkanoate) resin (E) is not limited to a particular type, and may be any of the poly(3-hydroxyalkanoate) resins mentioned above for the P3HA resin (A). Components other than the poly(3-hydroxyalkanoate) resin (E) are not limited to particular materials. Any components known as additives for resin layers, or other resins, may be used as appropriate.

The second resin layer can function as a substrate layer for the first resin layer (i.e., the film according to one or more embodiments). The substrate layer is a layer for ensuring the primary physical properties such as strength of the laminate.

The method for forming the second resin layer is not limited to a particular technique, and may be a co-extrusion method, a dry lamination method, an extrusion lamination method, or a coating method.

A third resin layer that functions as a heat-sealable layer may be further provided on the second resin layer. The resin used to form the third resin layer is not limited to a particular type. In order to enhance the biodegradability of the entire laminate, the third resin layer may contain a poly(3-hydroxyalkanoate) resin (F). The poly(3-hydroxyalkanoate) resin (F) is not limited to a particular type, and may be any of the poly(3-hydroxyalkanoate) resins mentioned above for the P3HA resin (A). Components other than the poly(3-hydroxyalkanoate) resin (F) are not limited to particular materials. Any components known as additives for resin layers, or other resins, may be used as appropriate.

Further examples of the other layer of the laminate include vapor-deposited layers and printed layers. In particular, since the film according to one or more embodiments exhibits improved printability and vapor deposition properties, a vapor-deposited layer or a printed layer can be provided directly on the surface of the film according to one or more embodiments. Such a vapor-deposited layer or printed layer can exhibit good adhesion. Thus, in the laminate according to one or more embodiments, the first resin layer can function as a layer for vapor-deposited layer formation or printed layer formation. The laminate according to one or more embodiments may include a vapor-deposited layer or a printed layer on at least a portion of the surface of the first resin layer.

The vapor-deposited layer may typically be made of an inorganic material. Examples of the inorganic material include metals, inorganic oxides, and carbon. Specific examples include, but are not limited to, aluminum, aluminum oxide, silicon oxides (such as silicon monoxide, silicon dioxide, and silicon oxynitride), cerium oxide, calcium oxide, and diamond-like carbon. One of these materials may be used alone, or two or more thereof may be used in combination. In terms of post-vapor-deposition adhesion, the vapor-deposited layer may be a vapor-deposited metal layer, a vapor-deposited metal oxide layer, or a vapor-deposited silicon oxide layer, or a vapor-deposited aluminum layer, a vapor-deposited aluminum oxide layer, or a vapor-deposited silicon oxide layer.

The thickness of the vapor-deposited layer is not limited to a particular range. In terms of productivity, handleability, and appearance, the thickness may be from about 1 to about 1000 nm, and may be from 2 to 50 nm or from 3 to 100 nm.

The vapor-deposited layer can be formed by a known method such as vacuum deposition.

The printed layer is not limited to particular details, and can be formed by a known printing method using a known printing ink. Examples of printing methods include gravure printing, offset printing, gravure offset printing, flexographic printing, and inkjet printing. The printing ink may be solvent-based or water-based. The printed layer may be a single layer or may consist of a plurality of layers.

In a laminate according to an aspect, the second and third resin layers may be provided on one side of the first resin layer which is the film according to one or more embodiments, and the vapor-deposited layer and/or the printed layer may be provided directly on the other side of the first resin layer.

### [Applications of Film or Laminate]

The film or laminate according to one or more embodiments can be suitably used as a packaging film, a heat-sealable film, or a twist film.

In the following items, aspects of the present disclosure are listed. One or more embodiments of the present invention are not limited to the following items.

### [Item 1]

A resin composition for film molding, containing:
a poly(3-hydroxyalkanoate) resin (A); and
a polylactic acid resin (B), wherein
an amount of the polylactic acid resin (B) is from 20 to 65 wt % based on a total amount of the poly(3-hydroxyalkanoate) resin (A) and the polylactic acid resin (B),
an amount of a fatty acid amide (C) is from 0 to less than 0.5 parts by weight per 100 parts by weight of the poly(3-hydroxyalkanoate) resin (A), and
a total proportion of the poly(3-hydroxyalkanoate) resin (A) and the polylactic acid resin (B) in a total amount of the resin composition for film molding, excluding any inorganic filler, is 98.5 wt % or more.

### [Item 2]

The resin composition for film molding according to item 1, being substantially free of the fatty acid amide (C).

### [Item 3]

The resin composition for film molding according to item 1 or 2, wherein the poly(3-hydroxyalkanoate) resin (A) contains a poly(3-hydroxyalkanoate) copolymer (A1).

### [Item 4]

The resin composition for film molding according to item 3, wherein the poly(3-hydroxyalkanoate) copolymer (A1) is a copolymer that contains 3-hydroxybutyrate units and other hydroxyalkanoate units and in which a proportion of the other hydroxyalkanoate units in a total amount of the 3-hydroxybutyrate units and the other hydroxyalkanoate units is from 1 to less than 24 mol %.

### [Item 5]

The resin composition for film molding according to item 3 or 4, wherein the poly(3-hydroxyalkanoate) copolymer (A1) is a copolymer of 3-hydroxybutyrate units and 3-hydroxyhexanoate units.

### [Item 6]

The resin composition for film molding according to any one of items 1 to 5, wherein the poly(3-hydroxyalkanoate) resin (A) further contains a poly(3-hydroxybutyrate) (A2).

### [Item 7]

The resin composition for film molding according to any one of items 1 to 6, wherein the polylactic acid resin (B) is a crystalline polylactic acid resin.

### [Item 8]

The resin composition for film molding according to item 7, wherein the crystalline polylactic acid resin has a melting point lower than 160° C.

### [Item 9]

The resin composition for film molding according to any one of items 1 to 8, further containing a layered clay mineral (D).

### [Item 10]

The resin composition for film molding according to item 9, wherein an amount of the layered clay mineral (D) is from 1 to 8 parts by weight per 100 parts by weight of the poly(3-hydroxyalkanoate) resin (A).

### [Item 11]

A film containing:
a poly(3-hydroxyalkanoate) resin (A); and
a polylactic acid resin (B), wherein
an amount of the polylactic acid resin (B) is from 20 to 65 wt % based on a total amount of the poly(3-hydroxyalkanoate) resin (A) and the polylactic acid resin (B),
an amount of a fatty acid amide (C) is from 0 to less than 0.5 parts by weight per 100 parts by weight of the poly(3-hydroxyalkanoate) resin (A), and
a total proportion of the poly(3-hydroxyalkanoate) resin (A) and the polylactic acid resin (B) in a total weight of the film, excluding any inorganic filler, is 98.5 wt % or more.

### [Item 12]

The film according to item 11, wherein the film is a stretched film.

### [Item 13]

The film according to item 11 or 12, wherein the amount of the polylactic acid resin (B) is 30 wt % or more based on the total amount of the poly(3-hydroxyalkanoate) resin (A) and the polylactic acid resin (B).

### [Item 14]

A laminate including:
a first resin layer containing the resin composition for film molding according to any one of items 1 to 10; and
a second resin layer provided on the first resin layer.

### [Item 15]

The laminate according to item 14, wherein the second resin layer contains a poly(3-hydroxyalkanoate) resin (E).

### [Item 16]

The laminate according to item 14 or 15, further including a vapor-deposited layer on at least a portion of a surface of the first resin layer.

### [Item 17]

The laminate according to any one of items 14 to 16, further including a printed layer on at least a portion of a surface of the first resin layer.

### EXAMPLES

Hereinafter, one or more embodiments of the present invention will be described in more detail with reference to Examples and Comparative Examples. One or more embodiments of the present invention are not limited by these examples in any respect.

The following materials were used in the examples.

### (Poly(3-Hydroxyalkanoate) Resin (A))

Poly(3-hydroxybutyrate-co-3-hydroxyhexanoate) (P3HB3HH) resins A-1 and A-2 and poly(3-hydroxybutyrate) A-3 listed below were used as P3HA resins (A). The term “3HB” denotes 3-hydroxybutyrate repeating units, and “3HH” denotes 3-hydroxyhexanoate repeating units.

A-1: P3HB3HH (average 3HB/3HH ratio=94/6 (mol %/mol %), weight-average molecular weight=60×10⁴ g/mol)

This resin was produced according to the method described in Example 1 of WO 2019/142845 A1.

A-2: P3HB3HH (average 3HB/3HH ratio=88.9/11.1 (mol %/mol %), weight-average molecular weight=60×10⁴ g/mol)

This resin was produced according to the method described in an example (Material A-3) of WO 2013/147139 A1.

A-3: PHB (poly(3-hydroxybutyrate)) (weight-average molecular weight=35×10⁴ g/mol)

This resin was produced according to the method described in Comparative Example 1 of WO 2004/041936 A1.

### (Polylactic Acid Resin (B))

B-1: PLA (LX175 grade, manufactured by Total Corbion PLA, melting point peak temperature=155° C.)

### (Fatty Acid Amide (C))

C-1: Behenamide (BNT-22H, manufactured by Nippon Fine Chemical Co., Ltd.)

### (Layered Clay Mineral (D))

D-1: Talc (SG-200N15, manufactured by Nippon Talc Co., Ltd.)

### (Nucleating Agent)

E-1: Pentaerythritol abbreviated as PETL (Neulizer P, manufactured by Mitsubishi Chemical Corporation)

The evaluations described below were conducted in Examples and Comparative Examples.

### [Pellet Moldability]

In resin pellet molding, the strand discharged from the pelletizing die was immersed in a water bath at 45° C., and the time required for the strand to lose elasticity perceptible by tactile inspection was measured as the solidification time. The strand haul-off speed was 10 m/min, and the length of the water bath was 2 m. When the strand remained unsolidified after being extruded to a length of 2 m from the die, the strand was folded a plurality of times until solidification was complete. If the strand failed to solidify even after the total length of the folded strand reached 20 m, the strand was evaluated as “unsolidified”, which means that pellet molding was impossible.

### [Film Moldability]

Film moldability was evaluated based on the haul-off speed measured during T-die film production. The evaluation criteria were as set forth below. The “haul-off speed” refers to the maximum speed at which the film can be transferred from the cast roll to the subsequent roll without sticking to the cast roll, and serves as an indicator of whether the film has sufficiently solidified on the cast roll. If the haul-off speed exceeds the maximum speed, the point at which the film separates from the cast roll shifts in the rotational direction of the cast roll due to the tackiness of the film, with the result that the film is forcibly peeled from the cast roll during transfer.

### <Evaluation Criteria>

Good: The haul-off speed was 15 m/min or more.
Average: The haul-off speed was from 5 to less than 15 m/min.
Poor: The haul-off speed was less than 5 m/min.

### [Film Stretchability]

A film was prepared from resin pellets using a T-die and then continuously stretched to three times its original length in the MD direction (the flow direction during T-die film preparation) using a roll stretching machine within a temperature range of 60 to 70° C. The stretchability limit was evaluated according to the criteria set forth below.

In addition, the film stretched in the MD direction was fixed at both ends in the MD direction and stretched to five times its original width in the TD direction (the direction perpendicular to the MD direction) within a temperature range of 70 to 80° C. The stretchability limit was evaluated according to the criteria set forth below.

### <Evaluation Criteria>

Good: A stretched film was obtained without film breakage during stretching, and the obtained film showed no visually discernible signs of uneven stretching (unevenly stretched areas such as areas of non-uniform film thickness).
Average: A stretched film was obtained without film breakage during stretching, but the obtained film showed some visually discernible signs of uneven stretching (unevenly stretched areas such as areas of non-uniform film thickness).
Poor: Film breakage occurred during stretching, or the resulting film showed visually discernible signs of uneven stretching (unevenly stretched areas such as areas of non-uniform film thickness) over its entirety.

### [Film Thickness]

The thickness of the film was measured using a caliper at 10 points spaced at intervals of 10 cm in the TD direction. The arithmetic mean of the 10 thickness values was calculated as the film thickness.

### [Film Haze Value]

The haze value of the film having a thickness of 30 μm was measured using HZ-V3, a haze meter manufactured by Suga Test Instruments Co., Ltd., according to JIS K 7136-1:1999 and K 7316:2000.

### [Printability]

Using a water-based black brush pen, an ink was spread on the surface of each of the films produced in Examples and Comparative Examples to examine whether the film surface was repellent to the ink.
Good: The film surface did not repel the ink.
Poor: The film surface repelled the ink.

### [Vapor Deposition Properties]

A vapor-deposited layer (thickness=100 nm) containing aluminum as an inorganic material was formed on the surface of each of the films produced in Examples and Comparative Examples.

The vapor-deposited layer formation was performed on a 30 mm×30 mm cut piece of the film using a deposition system (UHSP-T2040H, manufactured by Shimadzu Industrial Systems Co., Ltd.) under an argon gas atmosphere.

The obtained film having the vapor-deposited layer was subjected to a cross-cut test (JIS K 5600-6), and the adhesion of the vapor-deposited layer was evaluated based on the proportion (%) of the area over which the vapor-deposited layer peeled in the entire tested surface.

### <Evaluation Criteria>

Good: The proportion of the area over which the vapor-deposited layer peeled was less than 25%.
Average: The proportion of the area over which the vapor-deposited layer peeled was from 25 to 75%.
Poor: The proportion of the area over which the vapor-deposited layer peeled was more than 75%.

### (Resin Pellet Production)

### Example 1

The poly(3-hydroxyalkanoate) resins A-1, A-2, and A-3 and the polylactic acid B-1 were used in the following proportions (relative to the total weight of the P3HAs and the PLA): A-1, 48 wt %; A-2, 4 wt %; A-3, 8 wt %; and B-1, 40 wt %. The layered clay mineral D-1 was dry-blended with these resins in an amount of 2 parts by weight per 100 parts by weight of the poly(3-hydroxyalkanoate) resins. The resulting resin material was fed into the hopper of a 26-mm-diameter corotating twin-screw extruder whose cylinder temperature and die temperature were set to 150° C. The resin material was melted and kneaded in the extruder and extruded as a strand through the die. The extruded strand was solidified by passing it through a water bath filled with hot water at 45° C. The solidified strand was cut using a pelletizer to obtain resin pellets P-1. During this process, pellet moldability was evaluated. The evaluation result is shown in Table 1.

### Examples 2 to 9

Resin pellets P-2 to P-9 were produced in the same manner as the pellets of Example 1, except that the formulation was changed as shown in Table 1. During these processes, pellet moldability was evaluated. The evaluation results are shown in Table 1.

### Comparative Examples 1 to 4

Resin pellets P-10 to P-13 were produced in the same manner as the pellets of Example 1, except that the formulation was changed as shown in Table 1. During these processes, pellet moldability was evaluated. The evaluation results are shown in Table 1.

TABLE 1

| | | | Units | Ex. 1 | Ex. 2 | Ex. 3 | Ex. 4 | Ex. 5 | Ex. 6 | Ex. 7 | Ex. 8 |
|---|---|---|---|---|---|---|---|---|---|---|---|
| | | | | P-1 | P-2 | P-3 | P-4 | P-5 | P-6 | P-7 | P-8 |
| Resin | P3HA (A) | A-1 (HH: 6 mol %) | wt % | 48 | 56 | 64 | 56 | 60 | 60 | 32 | 48 |
| composition | | A-2 (HH: 11 mol %) | wt % | 4 | 5 | 5 | 5 | 0 | 0 | 3 | 4 |
| | | A-3 (PHB) | wt % | 8 | 9 | 11 | 9 | 0 | 0 | 5 | 8 |
| | PLA (B) | PLA LX175 | wt % | 40 | 30 | 20 | 30 | 40 | 40 | 60 | 40 |
| | Fatty acid | Behenamide | parts by | 0 | 0 | 0 | 0.3 | 0 | 0 | 0 | 0 |
| | amide (C) | | weight*¹ | | | | | | | | |
| | Layered clay | Talc | parts by | 2 | 2 | 2 | 2 | 2 | 2 | 2 | 0 |
| | mineral (D) | | weight*¹ | | | | | | | | |
| | Another | PETL | parts by | 0 | 0 | 0 | 0 | 0 | 1 | 0 | 0 |
| | additive | | weight*¹ | | | | | | | | |
| | Total proportion of (A) + (B) | | wt % | 100 | 100 | 100 | 99.8 | 100 | 98.8 | 100 | 100 |
| | in composition excluding | | | | | | | | | | |
| | inorganic filler | | | | | | | | | | |
| Evaluation | Pellet | Strand | sec | 20 | 40 | 80 | 30 | 50 | 15 | 15 | 40 |
| results | moldability | solidification time | | | | | | | | | |

| | | | Units | Ex. 9 | Comp. 1 | Comp. 2 | Comp. 3 | Comp. 4 |
|---|---|---|---|---|---|---|---|---|
| | | | | P-9 | P-10 | P-11 | P-12 | P-13 |
| Resin | P3HA (A) | A-1 (HH: 6 mol %) | wt % | 48 | 80 | 60 | 48 | 48 |
| composition | | A-2 (HH: 11 mol %) | wt % | 4 | 7 | 0 | 4 | 4 |
| | | A-3 (PHB) | wt % | 8 | 13 | 0 | 8 | 8 |
| | PLA (B) | PLA LX175 | wt % | 40 | 0 | 0 | 40 | 40 |
| | Fatty acid | Behenamide | parts by | 0 | 0 | 0 | 0.5 | 0 |
| | amide (C) | | weight*¹ | | | | | |
| | Layered clay | Talc | parts by | 10 | 2 | 2 | 2 | 2 |
| | mineral (D) | | weight*¹ | | | | | |
| | Another | PETL | parts by | 0 | 0 | 0 | 0 | 2 |
| | additive | | weight*¹ | | | | | |
| | Total proportion of (A) + (B) | | wt % | 100 | 100 | 100 | 99.7 | 98.0 |
| | in composition excluding | | | | | | | |
| | inorganic filler | | | | | | | |
| Evaluation | Pellet | Strand | sec | 19 | Unsolid- | Unsolid- | 25 | 12 |
| results | moldability | solidification time | | | ified | ified | | |

*¹Parts by weight per 100 parts by weight of P3HA (A)

As shown in Table 1, resin pellets were successfully molded in Examples 1 to 9 and in Comparative Examples 3 and 4. In contrast, in Comparative Examples 1 and 2, in which no polylactic acid was incorporated, the strands failed to solidify under the testing conditions described above, and resin pellets were not obtained.

### (Biaxially Stretched Film Production)

### Example 10

The resin pellets P-1 were fed into a single-screw extruder whose cylinder temperature and die temperature were set to 160° C., and the resin material was extruded as a film through a T-die. The resulting molded film was cooled on a cast roll with a set temperature of 40° C. and then taken up onto a take-up roll. This film was continuously stretched to three times its original length in the MD direction using a roll longitudinal stretching machine at 60 to 70° C. Subsequently, the film was further stretched continuously in the width (TD) direction using a transverse stretching machine (clip tenter) at a stretch temperature of 70 to 80° C. and a stretch ratio of 5. The film subjected to biaxial stretching was then cooled to 50° C., and the ends of the width of the cooled film were trimmed to obtain a biaxially stretched film having a width of 1200 mm and a thickness of 30 μm. The above processes were carried out successively.

The film was inspected after the MD-direction stretching and after the TD-direction stretching to evaluate film stretchability. The resulting stretched film was assessed for thickness, haze value, printability, and vapor deposition properties. The evaluation results are shown in Table 2.

### Examples 11 to 20

Film production was performed in the same manner as in Example 10, except that the resin pellets used were changed as shown in Table 2. Film stretchability was evaluated, and the resulting stretched films were assessed for thickness, haze value, printability, and vapor deposition properties. The evaluation results are shown in Table 2.

In the film production of Example 11, the resin pellets P-1 were dry-blended with the polylactic acid B-1 before being fed into the extruder so that the proportion of the polylactic acid B-1 in the resulting film was 60 wt % (relative to the total weight of the P3HAs and the polylactic acid).

In Examples 13 and 14, the resin pellets P-3 were dry-blended with the polylactic acid B-1 before being fed into the extruder so that the proportion of the polylactic acid B-1 in the resulting film was 30 wt % or 40 wt %.

### Comparative Examples 5 and 6

Film production was performed in the same manner as in Example 10, except that the resin pellets used were changed as shown in Table 2. Film stretchability was evaluated, and the resulting stretched films were assessed for thickness, haze value, printability, and vapor deposition properties. The evaluation results are shown in Table 2.

TABLE 2

| | | | | Ex. | Ex. | Ex. | Ex. | Ex. | Ex. | Ex. | Ex. |
|---|---|---|---|---|---|---|---|---|---|---|---|
| | | | | 10 | 11 | 12 | 13 | 14 | 15 | 16 | 17 |
| Pellets used | | | | P-1 | P-1 | P-2 | P-3 | P-3 | P-4 | P-5 | P-6 |
| Formulation | P3HA (A) | A-1 (HH: 6 mol %) | wt % | 48 | 48 | 56 | 64 | 64 | 56 | 60 | 60 |
| | | A-2 (HH: 11 mol %) | wt % | 4 | 4 | 5 | 5 | 5 | 5 | 0 | 0 |
| | | A-3 (PHB) | wt % | 8 | 8 | 9 | 11 | 11 | 9 | 0 | 0 |
| | PLA (B) | PLA LX175 | wt % | 40 | 40 | 30 | 20 | 20 | 30 | 40 | 40 |
| | Fatty acid | Behenamide | parts by | 0 | 0 | 0 | 0 | 0 | 0.3 | 0 | 0 |
| | amide (C) | | weight*¹ | | | | | | | | |
| | Layered clay | Talc | parts by | 2 | 2 | 2 | 2 | 2 | 2 | 2 | 2 |
| | mineral (D) | | weight*¹ | | | | | | | | |
| | Another | PETL | parts by | 0 | 0 | 0 | 0 | 0 | 0 | 0 | 1 |
| | additive | | weight*¹ | | | | | | | | |
| | PLA adjustment | Final amount of PLA (B) | wt % | 40 | 60 | 30 | 30 | 40 | 30 | 40 | 40 |
| | in film | (Parenthesized is the | | | (+20) | | (+10) | (+20) | | | |
| | production | additional amount) | | | | | | | | | |
| | Total proportion of (A) + (B) | | | 100 | 100 | 100 | 100 | 100 | 99.8 | 100 | 98.8 |
| | in composition excluding | | | | | | | | | | |
| | inorganic filler | | | | | | | | | | |
| Evaluation | Film moldability | Haul-off speed | | Good | Good | Good | Good | Good | Good | Average | Good |
| results | Film | MD stretching | — | Good | Good | Average | Average | Good | Average | Good | Good |
| | stretchability | To 3 times at 60-70° C. | | | | | | | | | |
| | | TD stretching | — | Good | Good | Average | Average | Good | Average | Good | Good |
| | | To 5 times at 70-80° C. | | | | | | | | | |
| | Film | Thickness | μm | 30 | 30 | 30 | 30 | 30 | 30 | 30 | 30 |
| | properties | Haze value | % | 31 | 16 | 42 | 31 | 30 | 42 | 20 | 21 |
| | | Printability | — | Good | Good | Good | Good | Good | Good | Good | Average |
| | | Vapor deposition | — | Good | Good | Good | Good | Good | Average | Good | Average |
| | | properties | | | | | | | | | |

| | | | | Ex. | Ex. | Ex. | Comp. | Comp. |
|---|---|---|---|---|---|---|---|---|
| | | | | 18 | 19 | 20 | 5 | 6 |
| Pellets used | | | | P-7 | P-8 | P-9 | P-12 | P-13 |
| Formulation | P3HA (A) | A-1 (HH: 6 mol %) | wt % | 32 | 48 | 48 | 48 | 48 |
| | | A-2 (HH: 11 mol %) | wt % | 3 | 4 | 4 | 4 | 4 |
| | | A-3 (PHB) | wt % | 5 | 8 | 8 | 8 | 8 |
| | PLA (B) | PLA LX175 | wt % | 60 | 40 | 40 | 40 | 40 |
| | Fatty acid | Behenamide | parts by | 0 | 0 | 0 | 0.5 | 0 |
| | amide (C) | | weight*¹ | | | | | |
| | Layered clay | Talc | parts by | 2 | 0 | 10 | 2 | 2 |
| | mineral (D) | | weight*¹ | | | | | |
| | Another | PETL | parts by | 0 | 0 | 0 | 0 | 2 |
| | additive | | weight*¹ | | | | | |
| | PLA adjustment | Final amount of PLA (B) | wt % | 60 | 40 | 40 | 40 | 40 |
| | in film | (Parenthesized is the | | | | | | |
| | production | additional amount) | | | | | | |
| | Total proportion of (A) + (B) | | | 100 | 100 | 100 | 99.7 | 98.0 |
| | in composition excluding | | | | | | | |
| | inorganic filler | | | | | | | |
| Evaluation | Film moldability | Haul-off speed | | Good | Average | Good | Good | Good |
| results | Film | MD stretching | — | Good | Good | Good | Good | Good |
| | stretchability | To 3 times at 60-70° C. | | | | | | |
| | | TD stretching | — | Good | Good | Good | Good | Good |
| | | To 5 times at 70-80° C. | | | | | | |
| | Film | Thickness | μm | 30 | 30 | 30 | 30 | 30 |
| | properties | Haze value | % | 15 | 11 | 80 | 20 | 20 |
| | | Printability | — | Good | Good | Average | Poor | Poor |
| | | Vapor deposition | — | Good | Good | Average | Poor | Poor |
| | | properties | | | | | | |

*¹Parts by weight per 100 parts by weight of P3HA (A)

As shown in Table 2, Examples 10 to 20 provided good evaluation results for the printability and vapor deposition properties of the resulting films. In contrast, Comparative Example 5, in which the amount of the fatty acid amide (C) was large, showed unsatisfactory results for both printability and vapor deposition properties. Comparative Example 6, in which the total proportion of the P3HA resins (A) and the polylactic acid resin (B) in the composition excluding the inorganic filler was low, also exhibited unsatisfactory results for both printability and vapor deposition properties.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A resin composition for film molding, comprising:
a poly(3-hydroxyalkanoate) resin (A); and
a polylactic acid resin (B), wherein
the poly(3-hydroxyalkanoate) resin (A) comprises:
a poly(3-hydroxyalkanoate) copolymer (A1); and
a poly(3-hydroxybutyrate) (A2),
an amount of the polylactic acid resin (B) is from 20 to 65 wt % based on a total amount of the poly(3-hydroxyalkanoate) resin (A) and the polylactic acid resin (B),
an amount of a fatty acid amide (C) is from 0 to less than 0.5 parts by weight per 100 parts by weight of the poly(3-hydroxyalkanoate) resin (A), and
a total proportion of the poly(3-hydroxyalkanoate) resin (A) and the polylactic acid resin (B) in a total amount of the resin composition excluding inorganic fillers, is 98.5 wt % or more.

2. The resin composition for film molding according to claim 1, wherein the resin composition is substantially free of the fatty acid amide (C).

3. The resin composition for film molding according to claim 1, wherein
the poly(3-hydroxyalkanoate) copolymer (A1) is a copolymer that comprises 3-hydroxybutyrate units and other hydroxyalkanoate units,
wherein a proportion of the other hydroxyalkanoate units in a total amount of the 3-hydroxybutyrate units and the other hydroxyalkanoate units is from 1 to less than 24 mol %.

4. The resin composition for film molding according to claim 1, wherein the poly(3-hydroxyalkanoate) copolymer (A1) is a copolymer of 3-hydroxybutyrate units and 3-hydroxyhexanoate units.

5. The resin composition for film molding according to claim 1, wherein the polylactic acid resin (B) is a crystalline polylactic acid resin.

6. The resin composition for film molding according to claim 5, wherein the crystalline polylactic acid resin has a melting point of lower than 160° C.

7. The resin composition for film molding according to claim 1, further comprising a layered clay mineral (D).

8. The resin composition for film molding according to claim 7, wherein an amount of the layered clay mineral (D) is from 1 to 8 parts by weight per 100 parts by weight of the poly(3-hydroxyalkanoate) resin (A).

9. A film comprising:
a poly(3-hydroxyalkanoate) resin (A); and
a polylactic acid resin (B), wherein
the poly(3-hydroxyalkanoate) resin (A) comprises:
a poly(3-hydroxyalkanoate) copolymer (A1); and
a poly(3-hydroxybutyrate) (A2),
an amount of the polylactic acid resin (B) is from 20 to 65 wt % based on a total amount of the poly(3-hydroxyalkanoate) resin (A) and the polylactic acid resin (B),
an amount of a fatty acid amide (C) is from 0 to less than 0.5 parts by weight per 100 parts by weight of the poly(3-hydroxyalkanoate) resin (A), and
a total proportion of the poly(3-hydroxyalkanoate) resin (A) and the polylactic acid resin (B) in a total weight of the film excluding inorganic fillers is 98.5 wt % or more.

10. The film according to claim 9, wherein the film is a stretched film.

11. The film according to claim 9, wherein the amount of the polylactic acid resin (B) is 30 wt % or more based on the total amount of the poly(3-hydroxyalkanoate) resin (A) and the polylactic acid resin (B).

12. A laminate comprising:
a first resin layer that is the film according to claim 9; and
a second resin layer provided on the first resin layer.

13. The laminate according to claim 12, wherein the second resin layer comprises a poly(3-hydroxyalkanoate) resin (E).

14. The laminate according to claim 12, further comprising a vapor-deposited layer on at least a portion of a surface of the first resin layer.

15. The laminate according to claim 12, further comprising a printed layer on at least a portion of a surface of the first resin layer.
